(19) United States
(12) Patent Application Publication
(10) Pub. No.: US 2016/0101390 A1
(43) Pub. Date: Apr. 14, 2016

(54) MODIFICATION OF MEMBRANES WITH POLYDOPAMINE AND SILVER NANOPARTICLES FORMED IN SITU TO MITIGATE BIOFOULING

(71) Applicant: THE JOHNS HOPKINS UNIVERSITY, Baltimore, MD (US)

(72) Inventors: Kai Loon Chen, Ellicott City, MD (US); Li Tang, Fairfax, VA (US)

(21) Appl. No.: 14/689,085

(22) Filed: Apr. 17, 2015

Related U.S. Application Data
(60) Provisional application No. 62/061,405, filed on Oct. 8, 2014.
(60) Provisional application No. 62/061,715, filed on Oct. 9, 2014.
(60) Provisional application No. 62/100,943, filed on Jan. 8, 2015.

(51) Int. Cl. B01D 65/08; B01D 71/68; B01D 67/00; B05D 7/00

(52) U.S. Cl. CPC B01D 65/08; B05D 7/50; B01D 71/68; B01D 67/0088

(57) ABSTRACT

The present invention is directed to a method for modifying polymeric membranes to mitigate biofouling. More particularly, dopamine powder is dissolved in a buffer solution, and the membrane surface is exposed to the solution, resulting in the formation of a polydopamine thin film on the membrane. The surface of the polydopamine-modified membrane is then exposed to AgNO₃ solutions, resulting in the formation of silver nanoparticles (AgNPs) on the membrane surface. The resulting membrane is expected to be resistant to biofouling for at least two reasons. First, polydopamine is extremely hydrophilic and thus membranes modified with polydopamine are resistant to bacterial attachment, which is the first stage of the biofouling process. Second, silver nanoparticles are antimicrobial and these nanoparticles on the membrane surface serve to inactivate depositing bacteria, and thus, retard the growth and proliferation of bacteria on the membrane.

### CROSS REFERENCE TO RELATED APPLICATIONS

This application claims the benefit of U.S. Provisional Patent Application Nos. 62/061,405 filed Oct. 8, 2014, 62/061,715 filed Oct. 9, 2014, and 62/100,943 filed Jan. 8, 2015, each of which are incorporated by reference herein, in their entirety.

### GOVERNMENT SUPPORT

This invention was made with government support under CBET-1133559 awarded by the National Science Foundation. The government has certain rights in the invention.

### FIELD OF THE INVENTION

The present invention relates generally to membrane processes. More particularly, the present invention relates to a method for modification of membranes with polydopamine and silver nanoparticles formed in situ to mitigate biofouling.

### BACKGROUND OF THE INVENTION

Membrane filtration has become one of the most popular technologies for water purification and wastewater reuse because of its efficiency and effectiveness. However, biofouling, or the formation of biofilms on membranes, has been a major obstacle that hinders their widespread application in water treatment. Current efforts to mitigate biofouling have been placed on modifying membrane surfaces by enhancing their hydrophilicity.

Polydopamine (PDA) is a bioinspired polymer with a molecular structure similar to that of the adhesive proteins of mussels. PDA is highly hydrophilic because of the presence of catechol, quinone, and amine groups in its structure. In addition, PDA can adhere firmly to a wide variety of materials in the wet environment through covalent bonding, hydrogen binding, π-π stacking, metal coordination or chelation, and/or charge-transfer complexing. These unique features of PDA have been leveraged to enhance membrane hydrophilicity for use in membrane filtration.

Because of the presence of drag forces resulting from water permeation during membrane filtration, some microorganisms may still deposit on hydrophilic membranes. Therefore, it is also desirable to impart strong antimicrobial properties to the membranes to inactivate deposited bacteria. Recently, numerous studies have examined the effectiveness of silver nanoparticles (AgNPs) in mitigating membrane biofouling by taking advantage of their strong and broad-spectrum antimicrobial properties. Interestingly, Ag⁺ ions can be reduced by the catechol groups of PDA, resulting in the in situ formation of AgNPs on PDA-modified surfaces. Furthermore, the O- and N-sites of PDA can serve as anchors for the AgNPs through metal coordination via charge-transfer. Hence, the generation and immobilization of AgNPs on PDA-modified membranes can pave a new way to impart membranes with both anti-adhesive and antimicrobial properties simultaneously to mitigate membrane biofouling.

In recent years, tremendous efforts have been placed on modifying the membrane surface to enhance the hydrophilicity to resist the adhesion of microbial cells, including plasma treatment, blending, coating, grafting or layer-by-layer assembling with highly hydrophilic or hydrated polymers or nanoparticles. Most of the techniques require either a specific reactor or a specific membrane substrate in order to enable a successful modification, and thus there still lacks a facile surface modification technique that enables simple implementation and wide application to all the membrane materials. Therefore, a simple and general surface modification technique that enables simple implementation and wide application to all the membrane materials is still lacking.

Accordingly, there is a need in the art for a method of easily and effectively prevents biofouling of a membrane.

### SUMMARY OF THE INVENTION

The foregoing needs are met, to a great extent, by the present invention including a method for mitigation of biofouling of a membrane. The method includes dissolving dopamine powder in a buffer solution. The method also includes exposing a surface of the membrane to the solution, such that a polydopamine thin film is formed on the surface of the membrane. Additionally, the method includes exposing the surface of the membrane to an AgNO₃ solution to form silver nanoparticles (AgNPs) on the membrane surface.

In accordance with an aspect of the present invention, the method can include dissolving the dopamine in a Tris-buffer solution (1.0 g/L). The method includes creating a buffer solution that has a fixed pH of approximately 8.5. Additionally, the method can include exposing an active side of the membrane to the solution for approximately 6 hour. The method can also include exposing the membrane to 50 mM AgNO₃ solution to form AgNPs on the surface.

### BRIEF DESCRIPTION OF THE DRAWINGS

The accompanying drawings provide visual representations, which will be used to more fully describe the representative embodiments disclosed herein and can be used by those skilled in the art to better understand them and their inherent advantages. In these drawings, like reference numerals identify corresponding elements and:

FIG. 1 illustrates a schematic diagram of PDA modification and in situ formation of AgNPs on the membrane surface and environmental SEM image of PDA-720 membrane. White scale bar represents 5 μm.

FIG. 2 illustrates a graphical view of N(1s), S(2p), and Ag(3d) XP spectra of the surface of the base and modified membranes.

FIG. 3 illustrates BSE SEM images of base and modified membranes and mass loadings of AgNPs on modified membrane surfaces. Recording contrast and brightness levels were held constant for all images in order to insure proper BSE intensity comparisons between samples. White scale bars represent 2 μm.

FIGS. 4A-4D illustrate BSE SEM imaging and EDX analysis of PDA-1440 membrane. FIG. 4A illustrates a BSE SEM image of PDA-1440 membrane with white circle indicating location for EDX analysis (bright spot). FIG. 4B illustrates EDX spectrum of bright spot. FIG. 4C illustrates BSE SEM image of PDA-1440 membrane with white circle indicating location for EDX analysis (dark spot). FIG. 4D illustrates EDX spectrum of dark spot.

FIG. 5 illustrates a graphical view of contact angle values for various membranes, including base membrane, PDA-modified membrane, PDA/1min Ag-modified membrane, PDA/1h Ag-modified membrane, PDA/2h Ag-modified membrane, and PDA/12h Ag-modified membrane, according to an embodiment of the present invention.

FIG. 6 illustrates a graphical view of bacterial deposition rate coefficients, k_{obs}, for base membrane, PDA-modified membrane, PDA/1min Ag-modified membrane, PDA/1h Ag-modified membrane, and PDA/12h Ag-modified membrane.

FIG. 7 illustrates a graphical view of colony forming units for PDA-modified membrane, PDA/1min Ag-modified membrane, PDA/1h Ag-modified membrane, PDA/2h Ag-modified membrane, PDA/12h Ag-modified membrane, and PDA/24h Ag-modified membrane.

### DETAILED DESCRIPTION

The presently disclosed subject matter now will be described more fully hereinafter with reference to the accompanying Drawings, in which some, but not all embodiments of the inventions are shown. Like numbers refer to like elements throughout. The presently disclosed subject matter may be embodied in many different forms and should not be construed as limited to the embodiments set forth herein; rather, these embodiments are provided so that this disclosure will satisfy applicable legal requirements. Indeed, many modifications and other embodiments of the presently disclosed subject matter set forth herein will come to mind to one skilled in the art to which the presently disclosed subject matter pertains having the benefit of the teachings presented in the foregoing descriptions and the associated Drawings. Therefore, it is to be understood that the presently disclosed subject matter is not to be limited to the specific embodiments disclosed and that modifications and other embodiments are intended to be included within the scope of the appended claims.

The present invention is directed to a method for modifying polymeric membranes to mitigate biofouling. More particularly, dopamine powder is dissolved in a buffer solution, and the membrane surface is exposed to the solution, resulting in the formation of a polydopamine thin film on the membrane. The surface of the polydopamine-modified membrane is then exposed to AgNO₃ solutions, resulting in the formation of silver nanoparticles (AgNPs) on the membrane surface. The resulting membrane is expected to be resistant to biofouling for at least two reasons. First, polydopamine is extremely hydrophilic and thus membranes modified with polydopamine are resistant to bacterial attachment, which is the first stage of the biofouling process. Second, silver nanoparticles are antimicrobial and these nanoparticles on the membrane surface serve to inactivate depositing bacteria, and thus, retard the growth and proliferation of bacteria on the membrane.

The surface modifications with PDA and AgNPs formed in situ can reduce polysulfone membranes' propensity to bacterial adhesion and growth. Specifically, PSU membranes were modified with a PDA film to enhance membrane hydrophilicity and reduce bacterial attachment. The PDA-modified membranes were then exposed to AgNO₃ solutions to generate AgNPs in situ on the membrane surfaces, thereby imparting the membranes with strong antimicrobial properties. The increased membrane soaking time in AgNO₃ solution leads to the increase in the AgNP mass loading. During leaching tests of the modified membranes, the Ag⁺ ions released from the modified membranes were 2-3 orders of magnitude lower in concentration than the established maximum contaminant limit for drinking water, thereby providing a safe antimicrobial technology. The simple and efficient method to form AgNPs in situ on the membrane surface has the potential to enable in situ replenishment of AgNPs on the membrane surface when the AgNPs are depleted through dissolution over time. Therefore this facile and scalable membrane surface modification method presented in this study using bioinspired PDA and AgNO₃ solution to enhance membranes' bacterial anti-adhesive and antimicrobial properties simultaneously has great potential for membrane biofouling mitigation for water filtration processes.

Polydopamine (PDA), a bioinspired polymer with a molecular structure mimicking the structures of the adhesive proteins of mussels, is receiving increasing attention in the field of the material science. PDA is capable to adhere firmly on a wide variety of materials through covalent binding, hydrogen binding, π-π stacking, metal coordination or chelating, and charge-transfer complexing. In addition, PDA is highly hydrophilic due to the presence of catechol, quinone, and amine groups in the structure. These unique features of PDA have been leveraged to enhance membrane hydrophilicity for use in membrane filtration. In light of these features, research interests have been sparked in the field of membrane filtration to leverage the adhesive and hydrophilic properties of PDA to mitigate membrane biofouling. The modification of polymeric membranes with PDA enhanced membranes' biofouling resistance significantly. Nevertheless, due to the persistent convective permeation during membrane filtration, some microbial cells may still unavoidably deposit, accumulate, proliferate, and finally form a biofilm on the membrane surface, even though the membrane has been modified and imparted with the enhanced hydrophilicity. Therefore, it is desirable to further impart membranes with the antimicrobial property, enabling the complete inactivation of the deposited microbial cells and as a result, eliminating a biofilm formation.

Numerous efforts have been placed on the utilization of silver nanoparticles (AgNPs) to mitigate membrane biofouling because of the strong and wide-spectrum antimicrobial properties of AgNPs. The most commonly proposed antimicrobial mechanism of AgNPs is the release of antimicrobial silver ions resulting from the dissolution of AgNPs. AgNPs can be incorporated in the synthetic membranes by either embedding AgNPs in the membrane matrix or immobilizing AgNPs on the membrane surface. The second method is advantageous, not only because it can prevent the AgNP aggregation, but also maximize the exposure opportunities of AgNPs to the microbial cells deposited on the membrane surface. The deposited microbial cells that directly contact or are in close proximity to AgNPs encounter a considerably high lethal concentration of free dissolved Ag ions. Interestingly, PDA can serve as both a strong reducing agent that reduces Ag ions to form AgNPs by the unreacted catechol groups and an anchor for the resultant AgNPs by the O-sites and N-sites. The method of forming AgNPs in situ not only saves the extra cost of AgNP synthesis and use of the chemical stabilizing agents, but also facilitates the possible repeat reforming of the AgNPs on the membrane surface once AgNPs depletes after long time use. Therefore, the membrane surface coated with PDA becomes a platform for the secondary reaction with Ag ions to directly synthesize and immobilize, and repeatedly recharge AgNPs. In summary, membrane surface modification by coating with PDA and by the following soaking with AgNO₃ solution can pave a new way to impart almost all kinds of synthetic membranes with the enhanced hydrophilicity and antimicrobial properties in a simple-implemented way to mitigate biofouling.

The objective of this study is to leverage the versatile features of PDA and investigate the influence of the PDA coating and the in situ formation of AgNPs on the biofouling mitigation of polysulfone (PSU) membranes. In particular, the PSU membrane was coated with a thin layer of PDA and the active side of the resultant PDA-modified membrane was placed in contact with AgNO₃ solution to form AgNPs on membrane surface in situ. The bacterial deposition rate coefficients for the base and the PDA—as well as PDA/AgNPs-modified membranes were obtained with the aid of a direct microscopic observation membrane filtration system and were compared to evaluate the effect of PDA on membranes' bacterial anti-adhesive property. The colony forming units (CFU) counting method was employed to assess the effect of the in situ formation of AgNPs on membranes' the antimicrobial property. The soaking time of the PDA-modified membranes in AgNO₃ solution was varied to examine the impact of soaking time on the size and morphology of the AgNPs formed in situ, as well as membranes' bacterial anti-adhesive and antimicrobial properties. A stability test was performed to evaluate the stability and robustness of the PDA/AgNP-modifications on the membrane surface.

Exemplary Embodiment. Exemplary embodiments are included herein as an illustration of the present invention. These exemplary embodiments are included only as examples and are not meant to be considered limiting.

Polysulfone Membrane Fabrication. PSU microfiltration membranes were fabricated using the wet phase inversion process and were used as the base membranes for the preparation of PDA-modified membranes. PSU beads (Udel P3500; Solvay Advanced Polymers) were first rinsed and cleaned with deionized (DI) water (Millipore, Billerica) and then dried at 50° C. To prepare a casting solution, the PSU beads and LiCl powder (anhydrous, ≧99%; Sigma-Aldrich) were dissolved in 1-methyl-2-pyrrolidinone (NMP, ≧99%; Sigma-Aldrich) at 55° C. by continuous stirring for at least 24 h. The final composition of the casting solution was 15% PSU, 2% LiCl, and 83% NMP by weight. The casting solution was then stirred at room temperature (23 ° C.) until it cooled down and the solution was degassed by allowing it to stand at room temperature for at least 72h. To fabricate a PSU membrane, the casting solution was spread on the edge of a glass plate and a PSU film was cast using a stainless steel casting knife (Elcometer 3530/5 Adjustable Baker Film Applicator, Elcometer Limited) at a gate height of 60 μm. The glass plate with the thin PSU film was immediately transferred into a DI water bath at room temperature to initiate the phase inversion process. The membrane fabricated through this phase inversion process was then transferred and stored in fresh DI water for at least 24 h before use. Bacterial filtration tests were performed to verify that the PSU membranes can achieve 100% rejection of Escherichia coli cells used in this study.

Membrane Modification with Polydopamine. The modification of PSU membranes with PDA was performed using a custom-made polycarbonate flow cell. A PSU membrane was clamped tightly between the top and bottom plates of the flow cell with the active side of the membrane facing the crossflow channel (90 mm×38 mm×2 mm). Dopamine hydrochloride powder (0.1 g; Sigma-Aldrich) was dissolved in 100 mL of a 15 mM Trizma hydrochloride (≧99.0%; Sigma-Aldrich) buffer solution with the pH adjusted to 8.5. Under this condition, dopamine can be oxidized by oxygen and self-polymerize to form PDA. The PDA solution was circulated across the membrane surface using a peristaltic pump (Cole Parmer, Vernon Hills, Ill.) at a crossflow velocity of 2.2 mm/s for 6 h. Following that, the membrane surface was rinsed twice (10 min/rinse) with the buffer solution at the same crossflow velocity. Finally, the membrane was removed from the crossflow cell and rinsed under running DI water for 30 s.

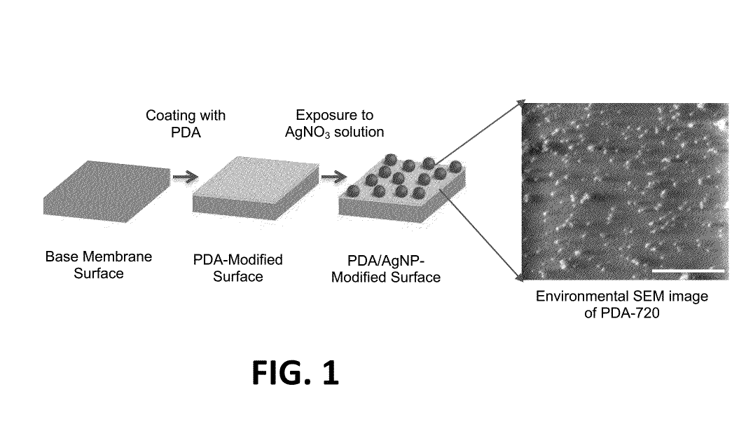

In situ Formation of AgNPs on Polydopamine-Modified Membranes. To generate AgNPs on the membrane surface, a PDA-modified membrane was allowed to float on a 50 mM AgNO₃ solution (pH unadjusted, volume of 25 mL) contained in a Petri dish, with the active side of the membrane contacting the solution. The Petri dish was covered with a piece of alumina foil to prevent exposure to light. The exposure time to the AgNO₃ solution was varied (1 min and 1, 2, 12, and 24 h) to investigate its effects on AgNP generation on the membranes. The membranes were then soaked in fresh DI water three times (at least 10 min for each soaking) before being used. The membrane surface modification process is illustrated in FIG. 1.

Membrane Characterization. The water contact angle measurements of PSU and modified membranes were performed using the sessile drop method on an optical CAM100 contact angle meter (KSV Instruments Ltd, Finland). The contact angle for each water (DI) droplet was the average of the contact angles on the left and right sides of the water droplet. Measurements for each membrane were conducted on at least four water droplets. The volume of each water droplet was 10 μL.

X-ray photoelectron spectroscopy (XPS) analysis of the membranes was conducted with a PHI 5600 XPS system using Mg Ka X-rays to determine the elemental composition on the membrane surface. The pass energy used to perform the survey scans to determine the elemental composition on the membrane surface was 58.7 eV at a scan rate of 1.000 eV/step.

Membrane samples were coated with 5 nm of carbon and examined in a JEOL 8600 Superprobe at 15 kV. Backscattered electron (BSE) images were obtained for each sample. Energy-dispersive X-ray (EDX) analyses were also collected to detect Ag in the membranes. Since BSE intensities are a function of mean atomic number and density, smaller particles will have lesser intensities than larger particles. Therefore, contrast settings for BSE images were kept constant for all images in order to compare particle density and size differences between different membranes. The BSE detector in the JEOL 8600 is an annular detector designed to minimize topographic effects of the BSE signal. However, this cannot be completely removed and some of the intensity differences between samples will be due to particle roughness that increases as particles increase in size. BSE imaging is also capable of detecting particles that are underneath or inside the PDA coatings.

Selected membranes were examined via environmental scanning electron microscopy (SEM) imaging to determine the distribution and morphologies of the AgNPs on the membrane surfaces. The morphology of the membrane surfaces was examined by secondary electron (SE) imaging using a low-vacuum Quanta 200 Environmental SEM (FEI, Hillsboro, Oreg.). Briefly, membrane samples were dried in vacuum; mounted onto aluminum stubs and imaged at room temperature at 1.8 kV, at a pressure of 100 Pa, a working distance of 5 mm, and a spot size of 3.0. Here, the topography of particles is emphasized and particles covered by the PDA will not be detected.

The AgNP mass loadings of the modified membranes were determined by soaking the membrane sample in a 3.5% HNO₃ solution and measuring the dissolved Ag concentrations with an atomic absorbance spectrometer (AAS). Specifically, a coupon (4.9 cm²) cut from a AgNP-modified membrane was soaked in a Pyrex glass bottle containing 20 mL of 3.5% HNO₃ solution. The solution was then stirred rigorously on a magnetic stirring plate to fully dissolve the AgNPs on the coupon. After 8 days of stirring, samples were withdrawn from the glass bottle and filtered through a 0.1 μm PVDF filter unit (Millex-VV, Merck Millipore Ltd.). The concentrations of the dissolved Ag in the samples were measured with an AAS (AAnalyst 100, Perkin Elmer). The AgNP mass loadings for the modified membrane were then calculated using the dissolved Ag concentrations.

Anti-Adhesive Properties of Membranes. The bacterial strain used in this study was Escherichia coli K12 MG 1655. The bacteria carry the antibiotic resistance gene and are labeled with the green fluorescent protein. The E. coli cells were incubated in a 25 g/L Luria Bertani (LB) broth (Fisher Scientific) that contained 50 mg/L kanamycin (Sigma-Aldrich) at 37° C. for ca. 3 h until the cells reached the mid-exponential growth phase. To prepare the bacterial suspension for the deposition experiments for the evaluation of the anti-adhesive properties of the membranes, the E. coli cells harvested at the mid-exponential growth phase were washed twice with 154 mM NaCl solutions through ultracentrifugation at 4° C. The final bacterial cell concentration in the feed suspension for the bacterial deposition experiments was ˜1.4×10⁷ cells/L.

The bacterial deposition experiments were performed with a direct microscopic observation membrane filtration system at room temperature. The closed-loop membrane filtration system was coupled with an epifluorescence microscope (Nikon Eclipse E600W, Japan) that was used to observe E. coli cell deposition on the membrane surface in real time. This system was first pressurized and stabilized with compressed nitrogen gas at ca. 25 psi. The feed solution was circulated at a crossflow velocity of 10 cm/s using a gear pump (Cole-Parmer, Vernon Hills, Ill.) through the crossflow cell and back to the pressure vessel (Alloy Products, Waukesha, Wis.). The permeation was maintained constant at 26 μm/s and circulated back to the pressure vessel using a peristaltic pump (Cole-Parmer, Vernon Hills, Ill.). The membrane to be tested was clamped between the top and bottom plates of the crossflow cell. The active side of the membrane faced the crossflow channel and the dimension of the flow channel was 76 mm in length, 25 mm in width, and 1 mm in height. The glass window on top of the crossflow cell enabled the real time observation of E. coli deposition on the membrane surface. The crossflow cell was placed on the stage of the epiflorescence microscope with a 10× objective lens. A digital camera (Roper Scientific, Photometrics CoolSnap ES, Germany) was used to acquire the images of deposited E. coli cells on the central part (107,078 μm²) on the membrane surface in real time.

Before each bacterial deposition experiment, the membrane was conditioned and equilibrated with a 10 mM NaCl and pH 7.0 (adjusted with 0.15 mM NaHCO₃) solution at a crossflow velocity of 10 cm/s and permeate flux of 26 μm/s for 40-50 min. The E. coli cells were then injected into the pressurized membrane filtration system using a syringe pump to initiate bacterial deposition under the same solution chemistry and hydrodynamic conditions. Each deposition experiment was conducted for 20 min, and the images of E. coli cells were acquired every 3 min. The deposition rate coefficient, k_{obs}, was calculated by normalizing the rate of bacterial deposition to the product of membrane surface area and cell concentration in the feed solution. The bacterial deposition experiments were conducted at least three times for each type of membrane.

Antimicrobial Properties of Membranes. The antimicrobial properties of the modified membranes were assessed using the colony forming unit (CFU) counting method. To prepare the E. coli suspension for the assessment of the membranes' antimicrobial properties, the bacterial suspension after the 3 h incubation was serial-diluted with 154 mM NaCl solutions (pH unadjusted) to ˜240 cells per mL. A circular membrane coupon (diameter=4.1 cm) was placed on top of the glass support of a vacuum filtration setup (Millipore, Billerica, Mass.) with the active side facing up. A diluted E. coli suspension (25 mL;˜240 cells/mL) prepared in a 154 mM NaCl (pH unadjusted) solution was filtered through the membrane by applying vacuum. The filtration took 8-10 min and the permeate flux during filtration was 31.6-39.5 μm/s. After filtration, the membrane coupon was placed on an agar plate (25 g/L LB, 15 g/L agar, and 50 mg/L kanamycin) with the back-side of the membrane resting on the agar. The agar plate was incubated at 37° C. for ca. 15 h and the CFUs on the central part of the membrane (area of 4.9 cm²) were enumerated the following day. Triplicate tests were performed for each membrane.

Stability of AgNPs Immobilized on Membranes. To test the stability of the AgNPs that were immobilized on the membranes, a Ag leaching test was performed. Specifically, a membrane was placed on top of the glass support of a vacuum filtration setup with the active side facing up. DI water (750 mL) was filtered through the membrane for 220-340 min at an average permeate flux of 34.4 μm/s, which is in the typical range of flux for microfiltration (MF) processes. The filtrate was collected and diluted in 3.5% HNO₃. The Ag concentration was analyzed using an inductively coupled plasma mass spectrometry (ICP-MS) instrument (PerkinElmer ICP Mass Spectrophotometer NexION 300D). Additionally, the antimicrobial properties of selected modified membranes after filtration were assessed by the CFU counting method. These experiments were triplicated for each membrane.

Results and Discussion

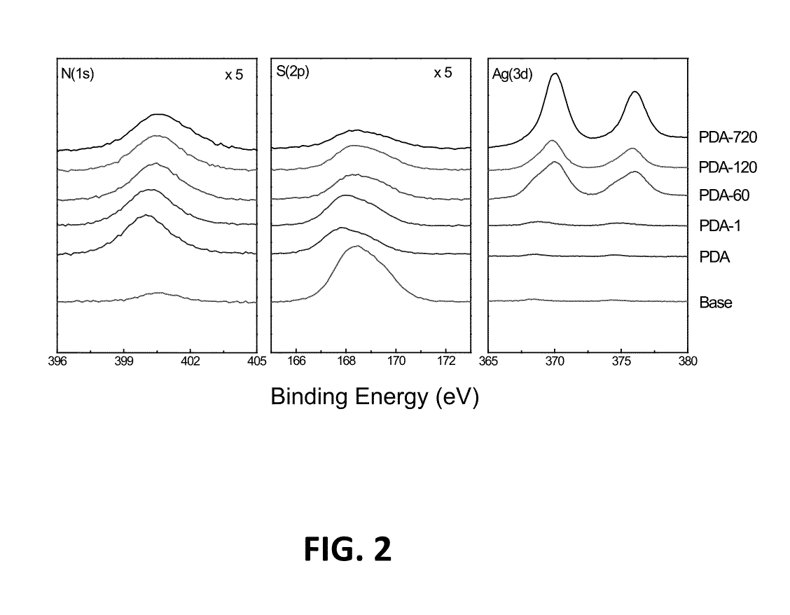

AgNP Mass Loading Increases with the Duration of Exposure to AgNO₃ Solutions. The designations used in this paper are “PDA membranes” for membranes modified with PDA only and “PDA-t membranes” for PDA-modified membranes exposed to AgNO₃ solutions for a duration of t min. The elemental composition of the membrane surfaces was analyzed by XPS (FIG. 2). The spectra of all the modified membranes showed similar signal intensities in the N(1s) region, all of which were higher than that of the base membrane. This observation confirmed the formation of a PDA film on all the modified membranes because nitrogen is present in PDA. All the modified membranes also exhibited signal intensities in the S(2p) region noticeably lower than those of the base membrane, likely because of the sulfone groups in the base PSU membrane being suppressed by the PDA film.

Strong signal intensities in the Ag(3d) region were clearly observed in the XPS spectra of all the PDA/Ag-modified membranes, except for the PDA-1 membrane in which the Ag concentration was probably too low to be detected. Secondary electron (SE) imaging via environmental SEM also revealed the presence of individual spherical AgNPs on the surface of the modified membranes (FIG. 1). In contrast, no detectable signal in the Ag(3d) region was observed for the PSU and PDA membranes (FIG. 2), and no AgNPs were found on both membranes. Additionally, the signal intensities in the Ag/3d) region for the PDA/Ag-modified membranes increased as the membrane exposure time was increased (FIG. 2). These findings indicate that the AgNP mass loading can be controlled by a simple variation of the exposure time to the AgNO₃ solutions and potentially the concentrations of the AgNO₃ solutions.

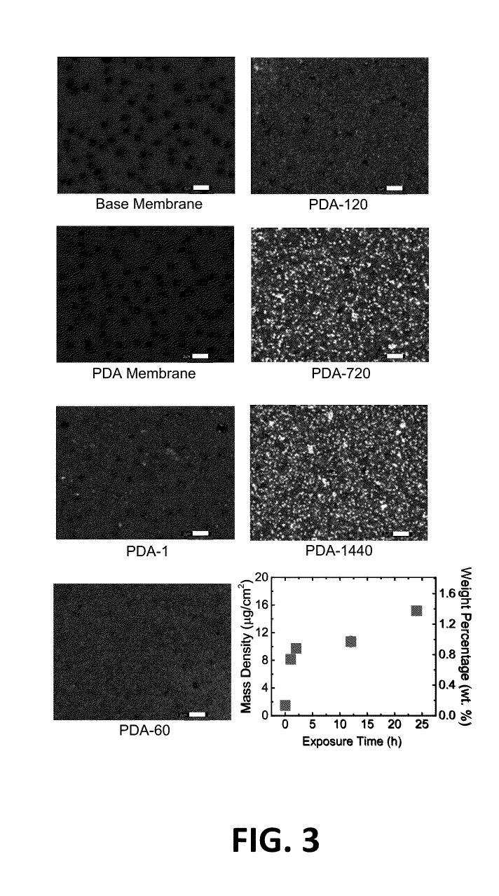

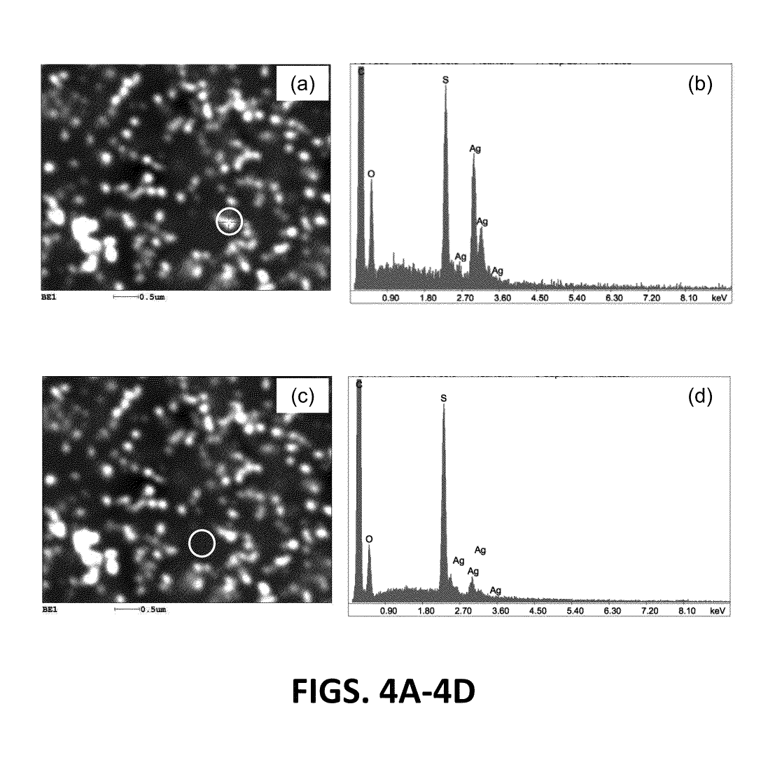

Backscattered electron (BSE) SEM images in FIG. 3 indicated that some of the pores of the modified membranes appeared to be covered by the PDA film. Additionally, bright spots were detected in the images of the PDA/Ag-modified membranes. Through EDX analysis, the Ag signal on the bright spots was shown to be high while the Ag signal on the dark spots was almost undetectable (FIG. 4), thus demonstrating the bright spots to be the locations of AgNPs. It is noteworthy that BSE imaging, which uses high energy electrons, is capable of detecting AgNPs that are underneath or inside the PDA film, unlike SE imaging that uses low energy electrons and can provide only images of AgNPs exposed on the membrane surface. The SEM image of PDA-720 (FIG. 1) appears to show fewer AgNPs than the BSE image (FIG. 3), which is consistent with AgNPs located both on the surface of and inside the PDA film.

From the images in FIG. 3, the distribution of AgNPs on the modified membrane surfaces was shown to be homogeneous. Also, the AgNPs increased in size and number as a function of duration of exposure of the membrane to AgNO₃ solutions. The AgNP mass loadings of the membranes were determined by soaking the membranes in HNO₃ solutions. AAS analysis of the acid solutions showed that the AgNP concentrations in the membranes increased as a function of the duration of exposure to the AgNO₃ solutions (graph in FIG. 3), which corroborated the results from XPS and SEM analyses (FIGS. 2 and 3, respectively). Specifically, the AgNP mass loading on the membrane surface increased dramatically within 60 min and increased slowly afterward. It is suggested that most of the AgNPs nucleated quickly on the membrane surface because of the strong reducing catechol groups in PDA, while the increase in AgNP mass after 60 min might be due to slower postnucleation ripening mechanisms while Ag⁺ is further reduced.

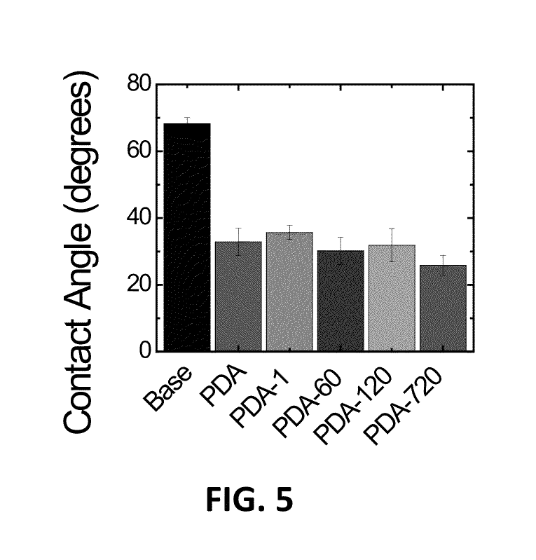

Surface Modifications Enhance Membrane Anti-Adhesive Properties. Water contact angle measurements on the membranes showed that surface modifications with PDA, as well as with PDA and AgNPs, reduced the membranes' contact angles by ˜50% compared to that of the base membrane (FIG. 5) and thus effectively enhanced their hydrophilicity. Furthermore, the contact angles on the membranes that were modified with PDA and AgNPs were independent of the AgNP mass loadings, thus indicating that the enhanced hydrophilicity of the modified membranes can be attributed to the PDA film.

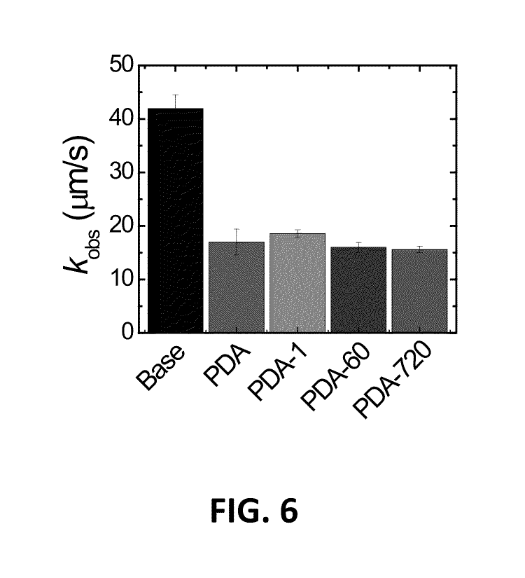

During the bacterial deposition experiments, the hydraulic resistance of the PSU base membranes was determined to be 3.0×10¹¹m⁻¹, while the hydraulic resistances of the PDA, PDA-1, PDA-60, and PDA-720 membranes were 9.6×10¹¹, 1.0×10¹², 9.8×10¹¹, and 1.1×10¹²m⁻¹, respectively. The hydraulic resistances of all the modified membranes were ˜2-3 times higher than that of the base membrane regardless of the Ag mass loadings. Hence, the major contributor to the increase in hydraulic resistance was the PDA film. The deposition experiments showed that PDA and PDA/AgNP modifications reduced the bacterial deposition kinetics on the membrane surface by ˜60% (FIG. 6). These results demonstrate that the PDA and PDA/AgNP modifications considerably enhanced the membrane's resistance to bacterial adhesion. Additionally, the k_{obs} values of the modified membranes were comparable and independent of the AgNP mass loadings. Because the hydrophilicity of all the modified membranes had increased considerably (FIG. 5), the enhanced bacterial anti-adhesive properties exhibited by the modified membranes are attributed to the hydrophilic PDA films. At the end of a separate crossflow filtration experiment using a PDA-60 membrane, a slight increase in the Ag concentration of 0.85 μg/L was detected in the circulated solution. The leaching of Ag was further investigated and will be discussed below.

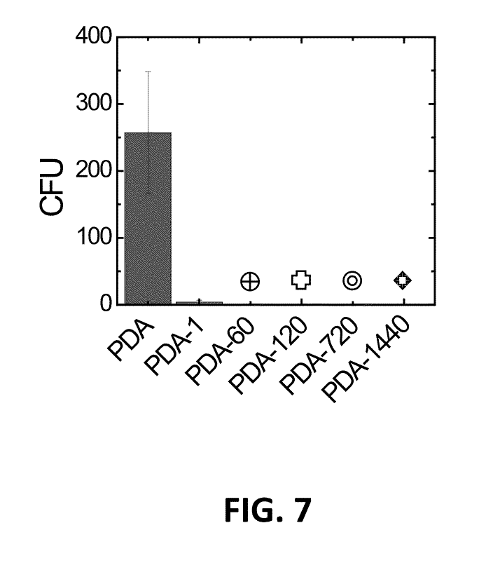

In Situ-Generated AgNPs Inhibit Bacterial Growth on Membranes. Using the CFU-counting method, 257 CFUs were observed on the PDA membrane while only 4 CFUs were observed on the PDA-1 membrane (FIG. 7). No CFUs were observed on the PDA-60, PDA-120, PDA-720, or PDA-1440 membranes. The result indicated that the in situ formation of AgNPs via exposure of PDA membranes to AgNO₃ solutions for ≧1 h can ensure the complete inactivation of bacterial cells. Despite the incomplete inactivation of E. coli cells, the PDA-1 membrane had a strong antimicrobial effect (close to 99%) comparable with that in other studies that used a similar method to evaluate the membrane's antimicrobial properties. In those studies, 0.9 wt % AgNPs were embedded in the membrane matrix and their results showed that the AgNP-impregnated membranes had a 99% reduction of E. coli cell growth In comparison, the similar antimicrobial effect achieved with a lower AgNP weight percentage in the present study (0.12±0.02 wt %) implied that the membrane's antimicrobial properties are greatly dependent on the location of AgNPs in the membrane structure. Recent studies demonstrated that the direct contact or proximity of bacteria to AgNPs, such as those immobilized on the membrane surface, maximizes the exposure of the bacteria to lethal concentrations of free released Ag⁺ ions dissolved from AgNPs. In contrast, not all the AgNPs embedded in the membrane matrix can be exposed to the deposited bacteria, and thus, a larger amount of AgNPs is required to achieve the same antimicrobial effect of AgNPs immobilized on the membrane surface. Therefore, the in situ formation of AgNPs on the membrane through the reduction of Ag⁺ ions by PDA is proven to be an efficient method for creating strong antimicrobial properties in the membranes as this approach ensured that AgNPs generated on the PDA films will have maximal opportunities for contact with deposited bacteria.

Stability of AgNPs Immobilized on Membranes. An Ag leaching test was conducted to quantify the degree of Ag release during filtration of DI water. The Ag concentrations in the permeates for the PDA-1 and PDA-60 membranes were 0.29±0.18 and 1.17±0.60 μg/L, respectively. These Ag concentrations were 2-3 orders of magnitude lower than the maximal contaminant limit of Ag in drinking water (i.e., 100 μg/L) established by the U.S. Environmental Protection Agency and also by the World Health Organization. Therefore, there would likely be no risk to health related to Ag ingestion if this PDA/AgNP membrane modification technique were to be applied to mitigate membrane biofouling for water filtration.

Additionally, the antimicrobial properties of the PDA-1 and PDA-60 membranes were examined after prolonged filtration of DI water. Only 2 CFUs were observed on the PDA-1 membrane surfaces, while no CFUs were observed on the PDA-60 membrane surfaces. These results were comparable to that on the freshly prepared PDA-1 and PDA-60 membranes (4 and 0 CFUs, respectively). Therefore, the dissolution and loss of AgNPs were low, and the AgNPs immobilized on the membrane surface could impart the membrane with long-lasting antimicrobial properties.

In summary, this study showed that PSU membranes modified with PDA and AgNPs formed in situ had enhanced resistance to biofouling versus that of the native PSU membranes. The PDA film was effective in reducing bacterial adhesion on the membrane surface, while the AgNPs imparted antimicrobial properties. Hence, this novel surface modification technique paves a way to mitigating biofouling by enhancing the membrane's anti-adhesive and antimicrobial properties, simultaneously. Additionally, this simple and efficient approach will allow the in situ modification of existing membranes of different configurations (such as hollow fiber and spiral wound), as well as feed spacers in spiral wound membranes, that are already in use in water and wastewater treatment plants. This approach may also allow for the in situ regeneration of AgNPs after they have been depleted through dissolution, thus enabling the sustainable application of nanocomposite membranes for water treatment.

The many features and advantages of the invention are apparent from the detailed specification, and thus, it is intended by the appended claims to cover all such features and advantages of the invention which fall within the true spirit and scope of the invention. Further, since numerous modifications and variations will readily occur to those skilled in the art, it is not desired to limit the invention to the exact construction and operation illustrated and described, and accordingly, all suitable modifications and equivalents may be resorted to, falling within the scope of the invention.

What is claimed is:

1. A method for mitigation of biofouling of a membrane comprising:
dissolving dopamine powder in a buffer solution to create a polydopamine solution;
exposing a surface of the membrane to the solution, such that a polydopamine thin film is formed on the surface of the membrane; and
exposing the surface of the membrane to an AgNO₃ solution to form silver nano-particles (AgNPs) on the membrane surface.

2. The method of claim 1 further comprising dissolving the dopamine in a Tris-buffer solution (1.0 g/L).

3. The method of claim 1 further comprising creating a buffer solution that has a fixed pH of approximately 8.5.

4. The method of claim 1 further comprising exposing an active side of the membrane to the solution for approximately 6 hours.

5. The method of claim 1 further comprising exposing the membrane to 50 mM AgNO₃ solution to form AgNPs on the surface.

6. The method of claim 1 further comprising using a polymeric membrane.

7. The method of claim 6 further comprising using a polysulfone membrane.

8. The method of claim 1 further comprising reducing Ag ions to form AgNPs with the polydopamine thin film.

9. The method of claim 1 further comprising binding AgNPs to the membrane with O-sites and N-sites on the polydopamine thin film.

10. The method of claim 1 further comprising fabricating the membrane with a wet phase inversion process.

11. The method of claim 1 further comprising using a polycarbonate flow cell to expose the membrane to the polydopamine solution.

12. The method of claim 11 further comprising clamping the membrane between top and bottom flow plates of the polycarbonate flow cell, with an active side of the membrane facing a crossflow channel in the flow cell.

13. The method of claim 1 further comprising exposing the membrane to AgNO₃ for one selected from a group consisting of 1 minute, 1 hour, 2 hours, 12 hours, and 24 hours.

14. A membrane comprising;
a membrane base having an active side;
a thin film formed at least on the active side of the membrane, the thin film taking the form of a polydopamine thin film;
silver nanoparticles (AgNPs) anchored to the polydopamine thin film.

15. The membrane of claim 14 further comprising the membrane taking the form of a polymeric membrane.

16. The membrane of claim 15 further comprising the membrane taking the form of a polysulfone membrane.

17. The membrane of claim 14 further comprising the AgNPs being formed on the membrane by soaking the membrane in an AgNO₃ solution.

18. The membrane of claim 14 further comprising the polydopamine thin film being formed by exposing the active side of the membrane to a dopamine solution.

19. The membrane of claim 14 further comprising anchoring the AgNPs to O-sites and N-sites on the polydopamine thin film.

20. The membrane of claim 14 further comprising the membrane being formed with a wet phase inversion process.
